(19) United States
(12) Patent Application Publication
(10) Pub. No.: US 2023/0264273 A1
(43) Pub. Date: Aug. 24, 2023

(54) TOOL FOR INSIDE CHIP SEPARATING PROCESSING OF A TUBE AND METHOD FOR USING THE TOOL

(71) Applicant: GMV AS, Sandnes (NO)

(72) Inventor: Richard Heng, Stavanger (NO)

(73) Assignee: GMV AS, Sandnes (NO)

(21) Appl. No.: 18/010,350

(22) PCT Filed: May 19, 2021
(86) PCT No.: PCT/NO2021/050124

§ 371 Date: Dec. 14, 2022

(30) Foreign Application Priority Data
Jun. 19, 2020 (NO) 20200723

(51) Int. Cl. B23C 5/00; B23C 3/00

(52) U.S. Cl. CPC B23C 5/006; B23C 3/00

(57) ABSTRACT

A tool is for inside chip-separating processing of a tube. The tool has a housing which is rotatable around a center axis of the tool, a blade holder which is rotatable around an axis of rotation, there being a plurality of blades positioned along the periphery of the blade holder, and a guide element which is arranged to guide the blade holder between an active position and a passive position. Each of the blades has a surrounding cutting edge which forms a working plane which is arranged perpendicularly to the centre axis of the tool. The blades are arranged for alternating contact with the tube when the blade holder is rotating and is in the active position.

### CROSS-REFERENCE TO RELATED APPLICATIONS

This application is the U.S. national stage application of International Application PCT/NO2021/050124, filed May 19, 2021, which international application was published on Jun. 16, 2022, as International Publication WO 2022/124904 in the English language. The International Application claims priority of Norwegian Patent Application No. 20200723, filed Jun. 19, 2020. The international application and Norwegian application are both incorporated herein by reference, in entirety.

### FIELD

The invention relates to a tool for chip-separating processing, so-called casing milling, of a steel tube, more particularly a casing in an oil and gas well. The invention also relates to a method for using the tool.

### BACKGROUND

When permanently closing an oil or gas well, it is required that at least 50 metres of the casing of the well should be removed before the well is plugged. This process is known as “casing milling” and, today, is typically performed with a rotating well tool with extendable blades. Each blade has a cutting edge which is adapted to the wall thickness of the casing. The blade and the cutting edge are in continuously rotatable engagement with the casing that is to be removed, so that a portion of the casing is cut away.

The method involves heavy wear on the blade as the well tool is operating in the casing. When a 13 ⅜″ tube is being removed, the capacity is typically 0.5 metres per hour, corresponding to 100 hours of effective cutting time by a length of 50 metres. Normally, one or more replacements of blades is/are required during the process. Replacing blades requires the tool to be pulled out of the well so that the blades can be changed, for example on a platform deck. When new blades have been fitted, the tool is lowered into the well again, and the milling can be resumed. This makes the method both time-consuming and expensive.

A problem with the prior art is that the blades produce so-called long chips, which may completely or partially block a necessary fluid flow in the well during the milling/grinding. The long chips must be pumped up to the drilling rig and be separated out.

Today's solutions for casing milling are time-consuming and resource-intensive. Alternative solutions are therefore sought.

### SUMMARY

The invention has for its object to remedy or reduce at least one of the drawbacks of the prior art or at least provide a useful alternative to the prior art.

The object is achieved through the features that are specified in the description below and in the claims that follow.

The invention is defined by the independent claims. The dependent claims define advantageous embodiments of the invention.

By chip-separating processing of a tube is meant, herein, the processing of a tube in which a portion of the tube is removed in a given axial length, for example by cutting, milling, filing or the like. The portion may form the full circumference of the tube. The processing may be a through-going one, so that all the material between an external surface of the tube and an internal surface of the tube is removed. By a 360-degree through-going processing, a portion of the tube wall is removed entirely, so that the tube is divided into a first part and a second part. The portion that is removed may typically have an axial length of 50 metres.

The tube may be a casing belonging to a petroleum installation. The tube may be positioned below a seabed. In technical language, the chip-separating processing that is described herein is referred to as casing milling.

In a first aspect, the invention relates to a tool for inside chip-separating processing of a tube, the tool comprising:
a housing which is rotatable around a centre axis of the tool;
a blade holder which is rotatable around a centre axis of the blade holder, and in which a plurality of blades are positioned along the periphery of the blade holder; and
a guide element which is arranged to guide the blade holder between an active position and a passive position. Each of the blades may have a surrounding cutting edge which forms a working plane arranged perpendicularly to the centre axis of each of the blades. The blades are arranged for alternating contact with the tube when the blades are in contact with the tube, the house is rotating, and the blade holder is rotating and is in the active position.

Each of the blades may be arranged to rotate around its centre axis when the blades are in contact with the tube, the house is rotating and the blade holder is in the active position, wherein the working planes of the blades deviating from a tool plane that coincides with the centre axis of the tool.

The blade holder and the blades may form part of a cutting tool.

An effect of the alternating contact between the plurality of blades and the tube is that the wear from the milling process may be distributed on several blades and across an, in aggregate, larger contact surface, which gives a longer service interval and a more effective chip-separating processing compared with the prior art. With a plurality of blades as is described herein, a complete processing of the tube may be provided without any replacing of blades. The cutting edge may be formed of a hard material, for example tungsten carbide. One or more blades may be circular. One or more rotatable blades may be polygonal.

Trials carried out by the applicant show that a rotating blade holder in which the blades are in alternating contact with a surrounding tube and rotate around several axes, as is described herein, produces more so-called fragmental chips and less so-called long chips than fixed blades that rotate only around the centre axis of the tube.

In one embodiment, the plurality of blades may be fixed to the blade holder. In an alternative embodiment, the plurality of blades may be part of the blade holder and positioned on the periphery of the blade holder. The blade holder may be formed of a hard material, for example tungsten carbide.

In an alternative embodiment, the plurality of blades may be freely rotatable. An effect of this is that the blades may be provided with a surrounding cutting edge, so that the contact surface of the cutting edge with the tube will be equal to the peripheral length of the blade. By a surrounding cutting edge is meant, herein, a cutting edge that follows the periphery of a circular or polygonal knife or blade. The surrounding edge may comprise two or more segments. The segments may be separated by a cut-out. An effect of the cut-out is that the surrounding cutting edge may be provided with a plurality of edges that may contribute to a more effective processing of the tube. By the working plane of the blade may be understood, herein, a plane that abuts against two or more cutting edges belonging to one blade, typical of a polygonal blade. If the blade has a plane working surface, the working plane may coincide with the plane working surface. If the working surface of the blade is concave or conical, the working plane may coincide with the periphery of the blade. By a working surface may be understood, herein, a surface on the processing side of the blade. The working plane of the blade may be arranged perpendicularly to the centre axis of a rotatable blade. The working plane of the blade may rotate around the centre axis of the tool and in the direction of rotation of the tool. The working plane may coincide with a working surface of the blade.

By the fact that the blade rotates, the cutting edge belonging to the rotatable blade may be kept in constant rotation so that the cutting edge may be kept sharp for a long time, and the life of the blade may be increased compared to that of a fixed blade.

Further, trials carried out by the applicant show that a rotatable blade holder with freely rotatable blades can give more fragmental chips than a rotatable blade holder with non-rotating blades. Thus, the drawbacks and problems that arise with long chips can be substantially reduced or completely eliminated. By only fragmental chips being produced, as made possible by the invention, the fragmental chips may sink down and stay in the well, as opposed to long chips which must be pumped out of the well and separated out. Thereby, in addition to giving a more effective processing of the tube, the invention can also eliminate the extensive process of pumping chips up to the surface with subsequent separation of the chips.

By the working plane of the blade deviating from a tool plane that coincides with the centre axis of the tool is meant, herein, that the working plane of the blade and the centre axis of the blade are angled relative to the centre axis and tool plane of the tool. The tool plane extends outwards in a radial direction from the centre axis of the tool. By the term deviating may be understood, herein, any position in which the working plane of the blade does not coincide with the tool plane. The working plane of the blade and the tool plane may cross. The deviating position may be provided by the blade being angled in one or more planes relative to the tool plane of the tool. The deviating position may be provided by the working plane of the blade being displaced parallel to the tool plane.

An effect of the working plane of the blade deviating from the tool plane is that a rotation of rotatable blades can be induced when the rotatable blades are in engagement with the tube and the tool is rotating.

If the working plane of the blade and the tool plane coincide, so that a blade arranged for rotation does not rotate, said blade may suffer point wear and breakage and process the tube to a lesser extent, if at all. When the working planes and centre axes of the blades are angled relative to the tool plane and centre axis of the tool, as is described herein, the blades can rotate so that point wear and breakage can be avoided even if the tool is rotating and does not have an axial motion.

An angle between the working plane of the blade and the tool plane may be between 3 and 10 degrees. The angle may be 5 degrees. The angle may be larger than 10 degrees. Trials show that 5 degrees gives a desired rotation of rotatable blades and desired processing of the tube.

In one embodiment, said angle may be provided by the blades being slanted relative to the blade holder. In an alternative embodiment, said angle may be provided by the blade holder being slanted relative to the guide element. In a further embodiment, the angle may be provided by the blades being slanted on the blade holder and the blade holder being slanted relative to the tool plane.

The guide element may be arranged to guide the blade holder between the passive position, the active position and further into a service position. In the service position, a portion of the blade holder is arranged to be positioned outside the tool so that the blade holder and/or the blades can be detached and maintained.

The centre axes of the blades may be parallel.

An effect of this is that the working planes of the blades may have an identical orientation, so that all the blades process the tube at an identical angle and position relative to the tool.

The blades may have one-sided support. The blades may have two-sided support.

One-sided support may simplify installation and removal of the blades. Two-sided support may give a more solid attachment of the blades and a reduced risk of breakage and axle fracture. Two-sided support may also reduce the risk of one or more blades coming loose if the tool must be reversed, for examples when being stuck.

The blade holder may be freely rotatable.

By the blade holder being freely rotatable is meant, herein, that the blade holder is non-driven. An effect of the blade holder being freely rotatable is that a chip-separating tool of simple construction may be provided. Rotation of the blade holder may be provided by the rotational axis of the blade holder being slanted relative to the centre axis of the tool plane, so that a periphery of the blade holder, including the peripherally positioned blades, touches the inside surface of the tube. Thereby, a rotation of the blade holder corresponding to the blades is induced when the tool is rotating around its centre axis. Induced rotation is a known principle and occurs when a wheel or a roller blade is slanted relative to the moving direction.

The blade holder may be driven.

An effect of this is that the blade holder can rotate independently of the rotation of the tool. Thus, the risk of point wear on the blades and/or breakage of the blades with subsequent pull-out of the tool for service may be reduced or avoided. Further, the blade holders being driven may simplify a release of the tool if sticking should occur.

The powering may be mechanical. The powering may be induced by a drill string. The powering may include a drive line with a worm drive. The powering may be distributed from a shared drive shaft to a plurality of blade holders via a transmission. The transmission may comprise an epicyclic transmission. The transmission may comprise one or more universal joints so that a rotating shaft can be moved radially in the tool. The transmission may include a gearing. The gearing may be, for example, 2:1 so that the speed of the drive line is reduced and the torque is increased. The transmission may be arranged to reverse the direction of rotation from that of a drill string so that the tool may have opposite rotation to that of a threaded connection between the casings. Thus, any loosening of the casings at the joints may be prevented.

The blades may be replaceable. The blade holder may be replaceable.

An effect of this is that the blades and the blade holder may be replaced independently of each other, so that the overall lifetime of the blade holder and blades can be optimized, and the operational costs can be kept as low as possible.

A further advantage of the blades being replaceable is that different blades may be used, depending on the wall thickness of the tube and the steel quality of the tube.

Replaceable blades may be attached to the blade holder via prior-art fastening means, for example screw connections, clamping connections or heat treatment.

The guide element may be pivotably connected to the housing.

An effect of the guide element being pivotable is that the guide element and the blade holder can be retracted into and extended from the housing in a simple manner. Further, a pivotable guide element is favourable because a pivotable guide element is subjected to a bending moment and a risk of sticking to a lesser extent, if at all. This can happen, for example, if the tool must be repositioned during the milling process and the processing by the blades starts below a finished cut edge on the tube so that the blades come into contact with a well wall surrounding the tube. The pivotable guide element may be an arm.

Further, a plurality of pivotable guide elements may be coupled to a shared linear actuator arranged along the centre axis of the tool, the actuator being arranged to move the blade holders in a radial direction via the guide elements. The actuator may be directly coupled to the guide elements. The actuator may be connected to a conical or wedge-shaped element which brings one or more guide elements to pivot so that the blade holder is displaced from the passive position into the active position.

The guide element may be spring-loaded in at least one direction, so that the guide element is moved from the active into the passive position when the actuator is pulling the conical or wedge-shaped element away from the guide element.

The actuator may be connected to one or more guide elements via a corresponding number of linking arms.

The tool that is described herein may have an outer diameter of less than 300 mm. In that connection, pivotable guide elements may give a favourable utilization of the space in that elongated guide elements may be positioned in the longitudinal direction of the tool when the blade holders are in the passive position.

The guide element may be displaceably connected to the housing.

The displaceable guide element may be arranged to be displaced perpendicularly to the centre axis of the tool. The displaceable guide element may be arranged to be displaced in a sloping direction relative to the centre axis of the tool. The displaceable guide element may be a slide element.

The blade holder may be displaced radially between the passive position and the active position by the guide element sliding in a linear guide. The linear guide may be slanted relative to the centre axis of the tool. The linear guide may have been fitted. The linear guide may be an integral part of the structure (guideways). The linear guide may be arranged to displace a plurality of blade holders.

An effect of the displaceable guide element is that the guide element and the blade holder are displaced at a fixed angle relative to tube wall.

The actuator may be hydraulic, mechanical or a combination of these. A hydraulic piston for activating the guide elements may be operated by a combination of a choke valve and a check valve, which allows a controlled, slow feed-out of the blades into the active position, and a quick return into the passive position. A mechanical operation of the actuator may be performed with one or more screws and/or with gears, for example rack and pinion.

The active position of the blade holder may be manipulated with an adjustable stop, so that the radial measurement of the periphery of the tool may be adjusted to the dimension of the tube that should desirably be processed.

The tool may comprise at least two blade holders.

An effect of at least two blade holders is that the tool can be centred in the tube, and the capacity of the tool can be doubled compared with that of just one blade holder.

In an advantageous embodiment, the tool may comprise three blade holders. The effect of three blade holders is that three blade holders give increased capacity and, at the same time, give a best possible centring and stability of the tool in the tube. Three blade holders can also give good utilization of the space available in the tool.

The blades may be positioned axially in the blade holder. By an axial positioning may be understood, herein, that the blades are mounted on a working side of the blade holder. By a working side may be understood the side of the blade holder that coincides with the direction of rotation of the tool. An effect of the blades being positioned axially in the blade holder is that the blades can be given an axial support and absorb great forces when the blades are in engagement with the tube.

The tool may comprise a chip separator arranged to pull out chips from mud in the tube. The chip separator may comprise a magnet arranged to attract chips. The chip separator may be connected to a conveyor screw arranged to carry the chips into a collecting receptacle. The collecting receptacle may be arranged on the chip separator.

In a second aspect, the invention relates to a system for casing milling for a petroleum well, the system comprising a tool according to the first aspect of the invention, a centring element and a tool holder.

By a tool holder is meant, herein, for example a drill string or a plurality of tubes that are connected and arranged to lower the tool into the well. The tool holder may comprise means for bringing the tool to rotate.

The centring element is arranged to centre the tool in the tube.

An effect of the system described herein is that casing milling of a casing may be carried out more quickly and more cost-effectively than what is possible with the prior art. By the tool producing so-called fragmental chips which may stay and sediment in the well, a positive environmental gain is also achieved, in that no energy is spent on separating the chips from a fluid in the well, and subsequent transport to shore and storage or destruction are avoided.

In a third aspect, the invention relates to a method for using the tool described in the first aspect of the invention for removing a portion of a tube, the method comprising the steps of:
lowering the tool into a tube and to a depth where a portion of the tube should desirably be removed;
providing a rotation of the housing around the centre axis of the tool;
moving at least one blade holder into an active position so that the plurality of blades come into contact with the tube wall;
moving the tool in an axial direction in the tube;
moving the tool at an adapted axial speed, so that there is time for the plurality of blades to penetrate the tube wall so that chips are separated in an uninterrupted length of the tube wall; and
stopping the rotation of the housing and moving the at least one blade holder into a passive position when the desired length of the tube has been removed.

### BRIEF DESCRIPTION OF THE DRAWINGS

In what follows, an example of a preferred embodiment is described, which is visualized in the accompanying drawings, in which:

FIG. 1 shows, in perspective, the tool positioned in a tube;

FIG. 2a shows the tool in an active position, seen from the side;

FIG. 2b shows the tool in the active position, seen from below;

FIG. 3a shows the tool in a passive position, seen from the side;

FIG. 3b shows the tool in the passive position, seen from below;

FIG. 4a shows a blade holder with rotatable blades;

FIG. 4b shows the blade holder of FIG. 4a from above;

FIG. 5 shows a blade holder with fixed blades;

FIG. 6a shows a side view of a cutting tool with angled blades;

FIG. 6b shows the cutting tool of FIG. 6a in perspective;

FIG. 7 shows a section of the tool; and

FIG. 8 shows the tool connected to a tool holder.

### DETAILED DESCRIPTION OF THE DRAWINGS

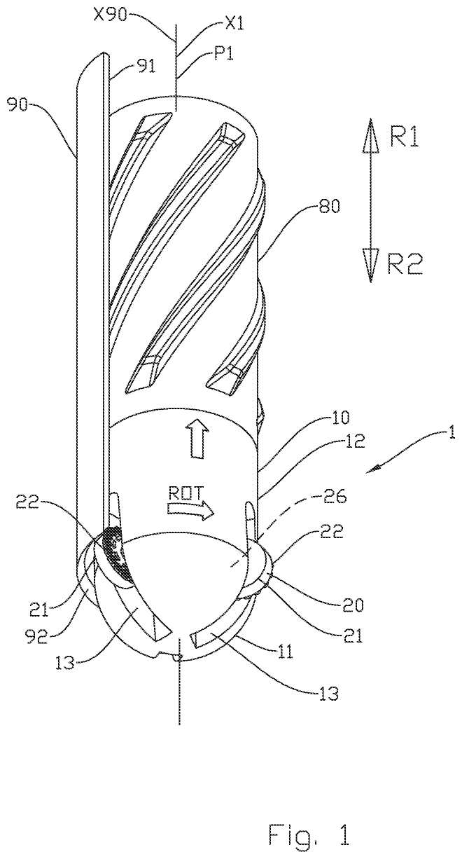

Reference is made first to FIGS. 1, 2a, 2b, 3a and 3b:

A tool 1 is mounted on a centring element 80 and shown positioned inside a tube 90 with an internal surface 91. A portion of the tube 90 has been removed in the FIGS. in order to better show the invention.

The tool 1 comprises a housing 10 which is shown with three cutting tools 20, each comprising a blade holder 21 provided with a plurality of blades 22. Three cutting tools 20 contribute to a self-centring effect of the tool 1 and the necessary stability of the tool 1 during internal processing of the tube 90.

The housing 10 comprises a cylindrical portion 12 and a rounded end portion 11. The rounded end portion 11 makes the tool 1 have a penetrating effect when the tool 1 is lowered down the tube 90 in the direction R2. The housing 10 comprises a slot 13 arranged to accommodate the cutting tool 20. In an alternative embodiment (not shown), the end portion 11 may have another penetrating shape. In an alternative embodiment (not shown), the end portion 11 may be adapted for being coupled to another tool or element.

The cylindrical portion 12 may be formed of a tube, rod element or casting. The rounded end portion 11 may be formed of a rod element or casting.

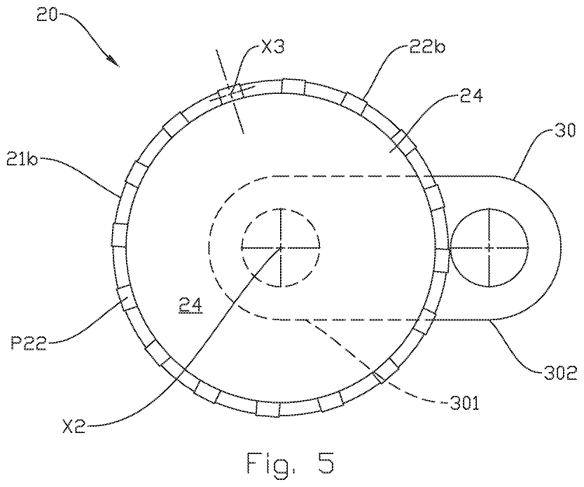

In FIGS. 1, 2a, 2b, 3a, 3b and 4, the blades 22 are shown as rotatable blades. The rotatable blades 22 are shown positioned axially on a working surface 24 of the blade holder 21. The blades 22 may be fixed blades 22, as shown in FIG. 5. In FIG. 5, the blades 22 are shown positioned radially to the working surface 24. When the tube 90 is to be processed, the tool 1 rotates in the direction ROT as shown in FIG. 1.

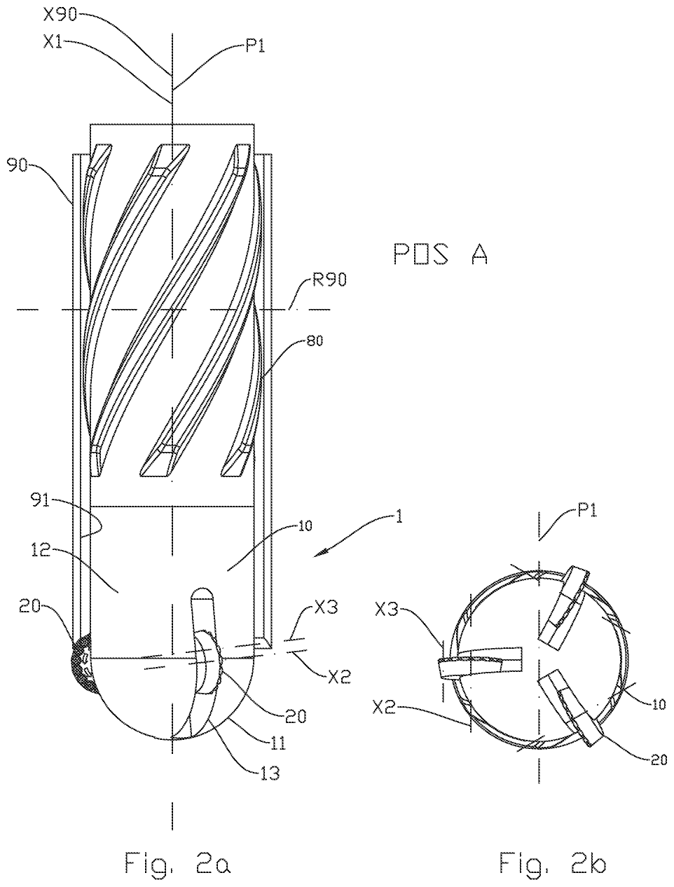

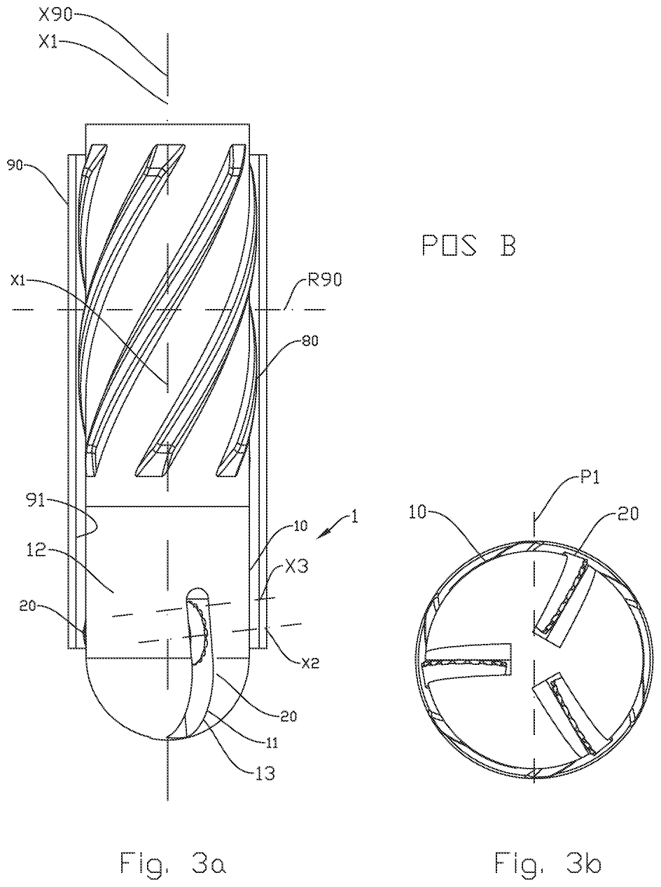

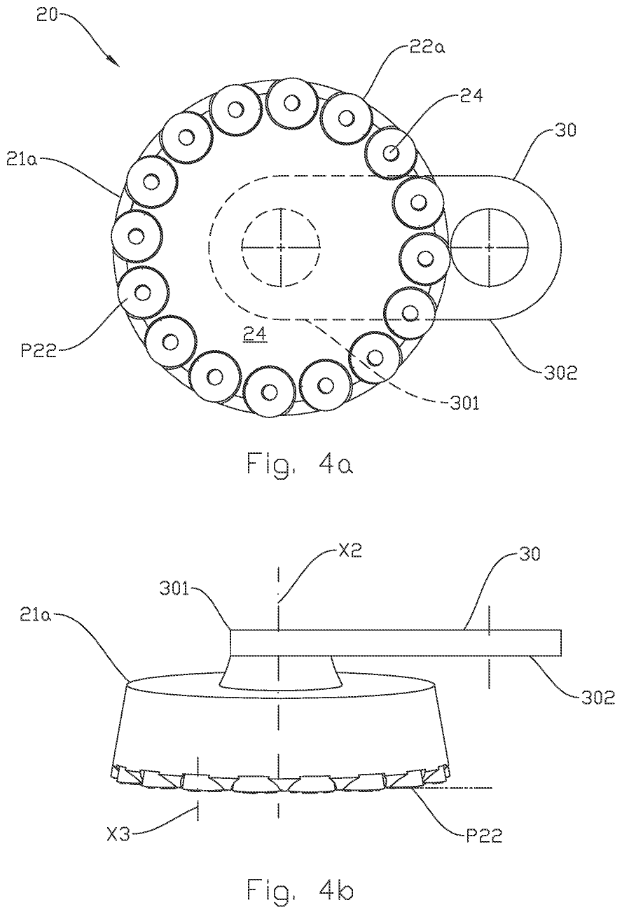

The cutting tool 20 is shown pivotably connected to the housing 10 via a guide arm 30 (FIGS. 4a, 4b and 5) so that the cutting tool 20 can be moved between an active position A, as shown in FIGS. 1, 2a and 2b, and a passive position B, as shown in FIGS. 3a and 3b.

The housing 1 is rotatable around a centre axis X1. The rotation may be provided by supplying a fluid to the tool 1. The fluid may be mud, for example. In an alternative embodiment not shown, the rotation may be provided by means of an electric motor.

Each blade holder 21 has an axis of rotation X2 which is slanted relative to the centre axis X1 of the tool, and each blade holder 21 is freely rotatable around its axis of rotation X2. By the axis of rotation X2 being slanted, a rotation of the blade holder 21 around its axis of rotation X2 may be provided when the blades 22 are in contact with the tube 90 and the housing 10 is rotating around its centre axis X1.

Each of the rotatable blades 22 can rotate freely around its blade axis X3. The blade holder 21 and the rotatable blades 22a may rotate independently of each other. By the blade holder 21 being rotatable, both the rotatable blades 22a and/or the fixed blades 22b that are mounted on the blade holder 21 may alternatingly be in cutting and rotating contact with an internal surface 91 of the tube 90.

The tool 1 is arranged to be lowered into the tube 90 in a direction R2. When the tool 1 is being lowered into the tube 90, the cutting tools 20 are positioned in the inactive position B, shown in FIGS. 3a and 3b, so that contact between the blades 22 and the tube 90 can be avoided.

When the tool 1 is in the desired position in the tube 90, the processing of the tube 90 may begin. The tool 1 is set in rotation around its centre axis X1 and moved in the working direction R1. The cutting tools 20 are moved out radially from the passive position B into the active position A so that the blades 22 come into contact with the internal surface 91 of the tube 90 and can subject the tube 90 to chip-separating processing.

When the tube 90 is being processed, each of the rotatable blades 22 may rotate around the three centre axes X1, X2 and X3, the blades being moved axially along the centre axis X1 at the same time. The effect of this is that the blades 22 can rotate and penetrate the tube wall through 360 degrees around the centre axis X1 in a desired axial length, for example 50 metres.

By the centre axes X3 of the rotatable blades 22 being slanted relative to the centre axis X1 of the tube and tool, the blades 22 and the blade holder 21 are brought to rotate, so that the blades 22 that are processing the tube 90 will rotate and alternate continuously.

The cutting tool 20 that is shown in FIGS. 1-4b has sixteen rotatable blades 22. If each blade 22 has a diameter of 20 mm, for example, this gives each blade 22 a cutting edge with a peripheral length of 63 mm. The total cutting-edge length of the cutting tool 20 as shown will then be approximately 1000 mm. The total cutting-edge length 23 of a tool 1 with three cutting tools 20 will then be 3000 mm. Thereby, in this example, the tool 1 may provide a plurality of cutting edges with a total peripheral length of 3000 millimetres.

An example: A tube 90 has an internal diameter of 340 mm and a wall thickness of 13 mm, corresponding to an area of 144 cm². The tube 90 is to be removed in a length of 50 metres, corresponding to a volume of 720 dm³. With the above example as a starting point, the invention makes 3000 mm of cutting edge available for processing 720 dm³ of steel (0.72 m³). By comparison, a prior-art tool with fixed blades will typically only have 100-300 mm of cutting edge available.

The cutting tool 20 is shown pivotably connected to the housing 10 via a guide element 30, shown as an arm in the figure. The length of the guide element 30 and the diameter of the cutting tool 22 may be adapted to the dimensions of the tube 90. The adjustment between the passive position A and the active position B can be done by using an actuator. The actuator may be a linear actuator.

FIGS. 4a and 4b show a cutting tool 20 with rotatable blades 22. The rotatable blades 22 can rotate around third centre axes X3. As shown in FIG. 4b, the blade holder 21 is slanted relative to the guide element 30.

FIG. 5 shows a cutting tool 20 with fixed blades 22b. As shown in FIG. 4b, the blade holder 21 is slanted relative to the guide element 30. The fixed blades 22b are shown with centre axes X3 that are perpendicular to the working planes of the blades 22b. The blades 22b in FIG. 5 are shown with a polygonal surrounding cutting edge consisting of four cutting-edge segments.

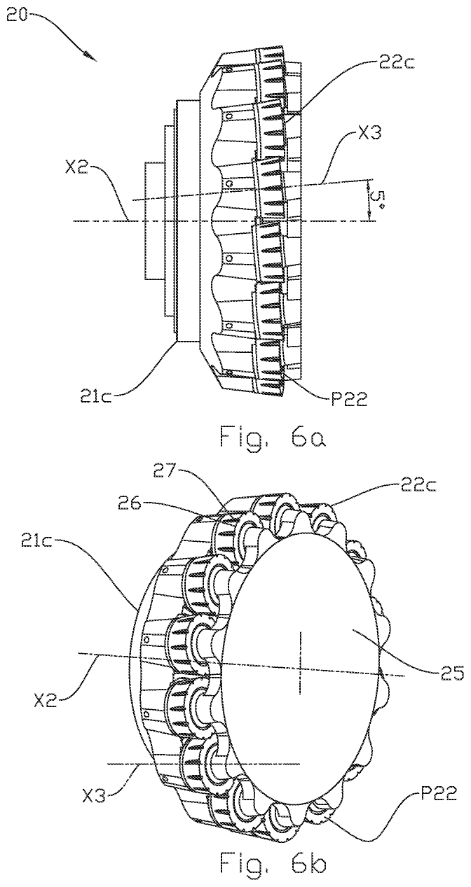

Reference is now made to FIGS. 6a, 6b, 7 and 8.

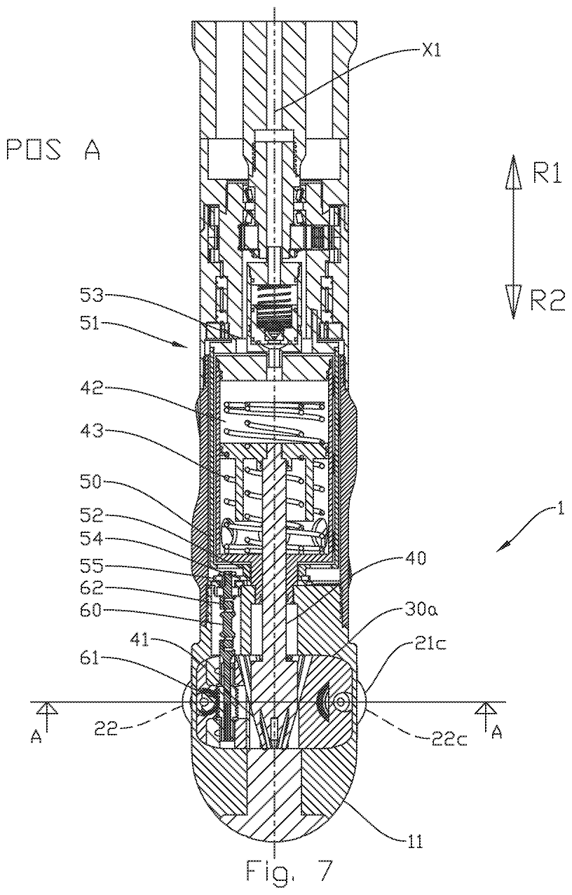

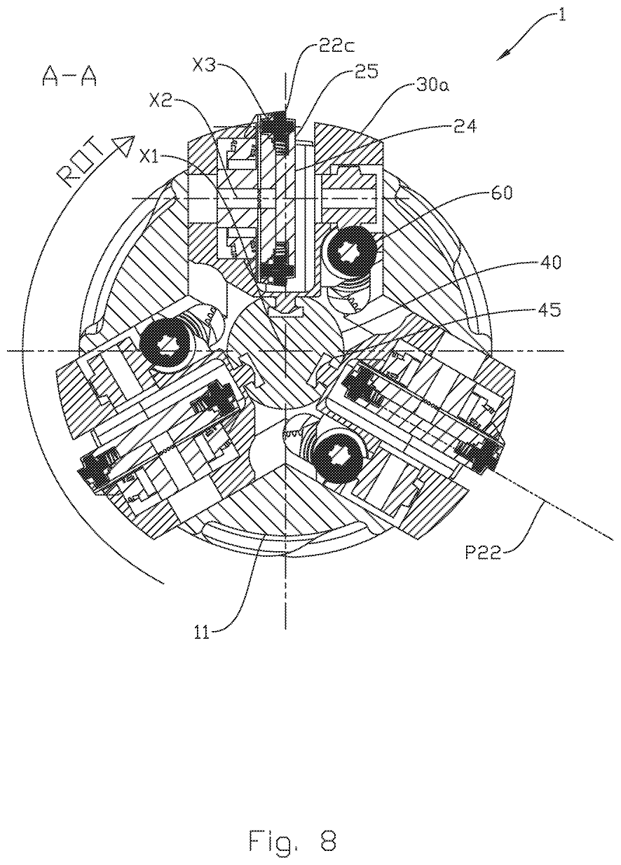

FIGS. 6a and 6b show a third embodiment 21c of the blade holder, in which a plurality of rotatable blades 22c are angled at 5 degrees relative to the centre axis X2 of the blade holder 21. In an embodiment not shown, the angle may be larger or smaller than 5 degrees. The blade holder 21c is arranged for perpendicular mounting to a displaceable guide element 30a, the centre axis X2 of the blade holder being arranged perpendicularly to the centre axis X1 of the tool 1, as shown in FIG. 7. As shown in FIG. 7, the displaceable guide element 30a may be arranged to be displaced perpendicularly to the centre axis X1 of the tool. The blades 22c are supported on two sides, there being a cover 25 mounted on a working side of the blades 22c. When the tube 90 (FIG. 1) is to be processed, the tool 1 rotates in the direction ROT as shown in FIG. 8. The blades 22c are circular and provided with surrounding cutting edges which are divided into a plurality of cutting-edge segments 26 separated by axial grooves 27. The blades 22c have working planes P22, the working planes P22 being arranged to process the tube 90 (FIG. 1).

The blade holder 21b may be displaced radially between the passive position B and the active position A by the guide element 30a sliding in a linear guide 40, shown as an actuator piston. At a first end 41, the linear guide 40 comprises a wedge with guideways 45 engaging with the guide element 30a. When the linear guide 40 is moved in the axial direction R2, the blade holder 21c is moved radially outwards, the blade holder being rotatably attached to the guide element 30a. When the linear guide 40 is moved in the axial direction R1, the blade holder 21c is moved radially inwards. The axial motion of the linear guide 40 is controlled by carrying liquid, for example mud, into a cylinder chamber 42. The pressure in the cylinder chamber 42 compresses a plurality of return springs 43. When the pressure in the cylinder chamber 42 is reduced, by liquid being drained from the cylinder chamber 42, the return springs push the linear guide back in the direction R1.

A tubular shaft 50 is rotatably connected, at a first end 51, to a drill string via an epicyclic transmission 53. The epicyclic transmission 53 may be arranged to reverse the direction of rotation from the drill string to the tubular shaft 50 to prevent casing from loosening at threaded connections (collars). Further, the epicyclic transmission 53 may change the number of revolutions so that the tubular shaft 51 may, for example, rotate at half the speed relative to the drill string and, at the same time, transmit a momentum twice as large. The tubular shaft 50 is connected, at a second end, to a centre gear 54 which is arranged to transmit a rotation to three drive lines 60 via gears 55 connected to each of the drive lines 60. Each of the drive lines 60 is connected to respective blade holders 21c. The drive lines 60 transmit the forces to the blade holders 21c via worm drives 61. The drive lines 60 may comprise a plurality of universal joints 62 so that the blade holders 21c can be driven regardless of their radial positions. When the tool 1 is operative, the housing 10 rotates around the tubular shaft 50.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1.-15. (canceled)

16. A tool for inside chip-separating processing of a tube, wherein the tool comprises:
a housing which is rotatable around a center axis of the tool;
at least two blade holders each comprising a plurality of blades positioned along the periphery of each blade holder; and
guide elements arranged to guide the blade holders between an active position and a passive position,
wherein each of the blades is arranged in use to alternatingly contact the tube when the blades are in contact with the tube, the housing is rotating and the blade holders are rotating and in the active position;
wherein each blade holder is rotatable around a center axis of the blade holder such that the blades alternatingly contact the tube in use.

17. The tool in accordance with claim 16, wherein each of the blades is arranged to rotate around its center axis when the blades are in contact with the tube, the housing is rotating and the blade holder is in the active position.

18. The tool in accordance with claim 16, wherein the center axes of the blades are parallel.

19. The tool in accordance with claim 16, wherein each of the blades has a surrounding cutting edge which forms a working plane;
wherein an angle between the working planes of the blades and the working plane of the tool is between 3 and 6 degrees.

20. The tool in accordance with claim 16, wherein the blades have two-sided support.

21. The tool in accordance with claim 16, wherein the blade holders are freely rotatable.

22. The tool in accordance with claim 16, wherein the blade holders are driven.

23. The tool in accordance with claim 16, wherein the guide element is pivotably connected to the housing.

24. The tool in accordance with claim 16, wherein the guide element is displaceably connected to the housing.

25. The tool in accordance with claim 24, wherein the guide element is connected to a linear actuator comprising a wedge-shaped end portion arranged to move the guide element in a radial direction.

26. The tool in accordance with claim 16, wherein the tool includes a rounded end portion.

27. A system for casing milling of a tube for a petroleum well, wherein the system comprises a centering element and a tool, wherein the tool further comprises:
a housing which is rotatable around a center axis of the tool;
at least two blade holders each comprising a plurality of blades positioned along the periphery of each blade holder; and
guide elements arranged to guide the blade holders between an active position and a passive position,
wherein each of the blades is arranged in use to alternatingly contact the tube when the blades are in contact with the tube, the housing is rotating and the blade holders are rotating and in the active position;
wherein each blade holder is rotatable around a center axis of the blade holder such that the blades alternatingly contact the tube in use.

28. A method for using a tool for removing a portion of a tube, the method comprising the steps of:
lowering the tool into a tube and to a depth at which a portion of the tube should desirably be removed;
providing a rotation of the housing around the center axis of the tool;
moving the tool in an axial direction in the tube;
moving at least one blade holder into an active position so that the plurality of blades engage with the tube in a processing manner;
moving the tool at an axial speed such that the plurality of blades penetrate the tube wall and chips are separated from the tube;
stopping the rotation of the housing 1, and moving the at least one blade holder into a passive position when a desired length of the tube has been removed.

29. The method in accordance with claim 28, wherein the method further comprises the step of providing a rotation of the blade holders.
